(19) United States
(12) Patent Application Publication
(10) Pub. No.: US 2015/0215405 A1
(43) Pub. Date: Jul. 30, 2015

(54) METHODS OF MANAGING AND STORING DISTRIBUTED FILES BASED ON INFORMATION-CENTRIC NETWORK

(71) Applicant: ELECTRONICS AND TELECOMMUNICATIONS RESEARCH INSTITUTE, Daejeon (KR)

(72) Inventors: Dong Myoung BAEK, Daejeon (KR); Seung Hyun YOON, Daejeon (KR); Bhum Cheol LEE, Daejeon (KR); Byeong Sik KIM, Daejeon (KR)

(21) Appl. No.: 14/604,202

(22) Filed: Jan. 23, 2015

(30) Foreign Application Priority Data
Jan. 24, 2014 (KR) 10-2014-0008755

(51) Int. Cl. H04L 29/08; G06F 17/30

(52) U.S. Cl. CPC H04L 67/1097; H04L 67/06; G06F 17/30203

(57) ABSTRACT

Provided are methods of managing and storing distributed files based on an information-centric network (ICN). A method of managing distributed files performed by an ICN node includes receiving a message for requesting provision of data from a first network node, determining whether a name of the requested data is identical to a name of data stored in the ICN node, and adaptively providing the data to the first network node based on a result of the determination. Accordingly, it is possible to reduce the overall network load by preventing duplication of a data access path.

### CLAIM FOR PRIORITY

This application claims priority to Korean Patent Application No. 2014-0008755 filed on Jan. 24, 2014 in the Korean Intellectual Property Office (KIPO), the entire contents of which are hereby incorporated by reference.

### BACKGROUND

1. Technical Field

Example embodiments of the present invention relate in general to a method of managing distributed files, and more particularly, to a method of managing distributed files in which the efficiency of a network can be improved when data is frequently read.

2. Related Art

With the advent of high-capacity multimedia data and social network services (SNSs), such as Facebook, data has been explosively increasing lately. To process such large amounts of data, a need for a distributed file system (DFS) which splits data in parallel and simultaneously processes the split data is increasing.

A DFS is a client-server-based file system that connects physically different computers via a network to provide file access spaces, which look the same to a user. In an environment in which a large number of users use different computers, a common file system can be provided via a network. DFSs are designed to overcome a performance limitation of existing centralized file systems in which the computation performance of a central processing unit (CPU) does not support a capability of processing inputs and outputs between nodes, which are functional units of data processing.

Among DFSs, a network file system (NFS), a common Internet file system (CIFS), a Hadoop distributed file system (HDFS), an owner-based file system (OwFS), etc. are mainly used, and various other DFSs are also in use. Because one DFS is not always advantageous and various DFSs have been made for different purposes, it is necessary to select an appropriate file system according to the purpose of service to be achieved.

Among these, the HDFS was designed to have a low probability of failure and to build and distribute hardware at a low cost compared to other DFSs. The system configuration of the HDFS includes one name node server and a plurality of data node servers. A name node controls access requests from clients while managing name spaces, such as directories, file names, and file blocks of the file system. Also, the name node divides one file into blocks and determines data nodes which the blocks will be appropriately distributed to and stored in. For stability of data, the name node manages blocks so that each of the blocks can be replicated at least three times and the copies can be stored in data nodes. The data nodes receive or provide data according to a request from a client.

When repeated access is made to the same file in the HDFS described above, the access is concentrated on a data node storing the file, and loads of the data node and network resources required to access the data node drastically increase. Therefore, overload may occur at the data node, or a bottleneck may occur in a network.

### SUMMARY

Accordingly, example embodiments of the present invention are proposed to substantially obviate one or more problems of the related art as described above, and provide a method of managing distributed files in which it is possible to prevent a bottleneck caused by the concentration of network loads when data is frequently read.

Example embodiments of the present invention also provide an apparatus for managing distributed files which performs the method of managing distributed files.

Other purposes and advantages of the present invention can be understood through the following description, and will become more apparent through example embodiments of the present invention. Also, it is to be understood that purposes and advantages of the present invention can be easily achieved by means disclosed in the claims and combinations of them.

In some example embodiments, a method of managing distributed files based on an information-centric network (ICN) performed by a name node includes: receiving a message for requesting provision of a storage name required to store or read data from a user terminal; generating a storage name so that the data indicated by the message is discriminable; and transmitting the generated storage name to the user terminal.

Here, the receiving of the message may include receiving characteristic information of the data from the user terminal.

Here, the generating of the storage name may include generating a storage name reflecting the received characteristic information of the data.

Here, the characteristic information of the data may include information such as a data name, a data size, a data type, a data generation date, a data modification date, a person who has generated the data, block numbers of the data, a copy number of the data, a location from which reading of the data will be frequently requested, and a location in which the data will be stored,

Here, the generating of the storage name may include, when a storage name reflecting the information of the location in which the data will be stored is generated, storing the characteristic information and the storage name in the form of metadata.

In other example embodiments, a method of storing distributed files performed by a user terminal based on an ICN includes: transmitting a message for requesting provision of a storage name required to store data to a name node; receiving the storage name from the name node; setting the received storage name as a name of the data; and providing the data whose name has been set to an ICN node.

Here, the transmitting of the message may include providing characteristic information of the data.

Here, the characteristic information of the data may include information such as a data name, a data size, a data type, a data generation date, a data modification date, a person who has generated the data, block numbers of the data, a copy number of the data, a location from which reading of the data will be frequently requested, and a location in which the data will be stored.

Here, the transmitting of the message may include, dividing the data into blocks of a predetermined uniform size, and transmitting a message for requesting storage names of the respective divided blocks to the name node.

In other example embodiments, a method of managing distributed files performed by an ICN node based on an ICN includes: receiving a message for requesting provision of data from a first network node; determining whether a name of the requested data is identical to a name of data stored in the ICN node; and adaptively providing the data to the first network node based on a result of the determination.

Here, the providing of the data may include, when the result of the determination indicates that the name of the requested data is identical to a name of data stored in the ICN node, providing the data stored in the ICN node to the first network node.

Here, the providing of the data may include: when the result of the determination indicates that the name of the requested data is not identical to a name of data stored in the ICN node, requesting provision of the data from a second network node connected to the ICN node; receiving the data in response to the request message; and providing the received data to the first network node.

Here, the providing of the received data may include storing the received data in a storage space of the ICN node, and providing the received data to the first network node.

Here, the method may further include generating a forwarding table based on a first rule defining storage names and data nodes corresponding to the storage names.

Here, the method may further include receiving a second rule used to generate the storage names from a name node.

Here, the method may further include updating the first rule based on the second rule.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram of an information-centric network (ICN) environment;

FIG. 2 is a block diagram showing a data writing structure of a Hadoop distributed file system (HDFS);

FIG. 3 is a block diagram showing a data reading structure of an HDFS;

FIG. 4 is a sequence diagram illustrating a process of writing distributed files based on an ICN according to an example embodiment of the present invention;

FIG. 5 is a sequence diagram illustrating a process of reading distributed files based on an ICN according to an example embodiment of the present invention;

FIG. 6 is a block diagram showing a structure of an ICN-based DFS according to an example embodiment of the present invention;

FIG. 7 is a block diagram showing a configuration of a name node according to an example embodiment of the present invention;

FIG. 8 is a block diagram showing a configuration of an ICN node according to an example embodiment of the present invention; and

FIG. 9 is a conceptual diagram showing a structure of an ICN-based DFS according to an example embodiment of the present invention.

### DESCRIPTION OF EXAMPLE EMBODIMENTS OF THE PRESENT INVENTION

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

It will be understood that, although the terms “first,” “second,” “A,” “B,” etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.). It will be understood that the term “connect” denotes not only a physical connection of an element stated herein but also an electrical connection, a network connection, and so on.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, numbers, steps, operations, elements, parts and/or combinations thereof, but do not preclude the presence or addition of one or more other features, numbers, steps, operations, elements, parts, and/or combinations thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “information-centric network (ICN)” refers to a network that focuses more on the purpose of communication than on the procedure of communication. In an existing client-server-based network structure, both ends participating in communication establish a connection relation with each other, and then transmit data packets through a single path. On the other hand, in an ICN, data is transmitted in a one-to-one manner or a one-to-many manner based on information which is meaningful for application building with a user, that is, not by giving information indicating a location, such as an Internet protocol (IP) address, but by giving a unique identifier or name to information. Various technologies including a named data network (NDN), a content-centric network (CCN), data-oriented network architecture (DONA), publish-subscribe interest (PSI), a network of information (NetInf), etc. can be considered as the same concept in terms of their aims in spite of slight differences in details.

The term “network node” refers to a connection point in a network, and may be either of end points as well as a data distribution point. In general, a network node performs a function of recognizing and processing data or transmitting data to another network node. For example, network nodes refer to various network devices transferring data in a network, such as a hub, a switch, a router, and a bridge, and various devices configuring a network end, such as a server, a terminal, and a personal computer (PC).

The term “metadata” is data for describing other data, that is, data given to other data according to predetermined rules so as to efficiently find and use the other data among a large amount of data. In general, the location and the content of data, information on a person who has generated the data, access conditions, use conditions, the history of use, etc. are stored in metadata. In a computer, metadata is generally used to rapidly find data, and serves as an index.

Hereinafter, example embodiments of the present invention will be described in detail with reference to the accompanying drawings. To facilitate general understanding of the present invention, like numbers refer to like elements throughout the description of the drawings, and the description of the same component will not be reiterated.

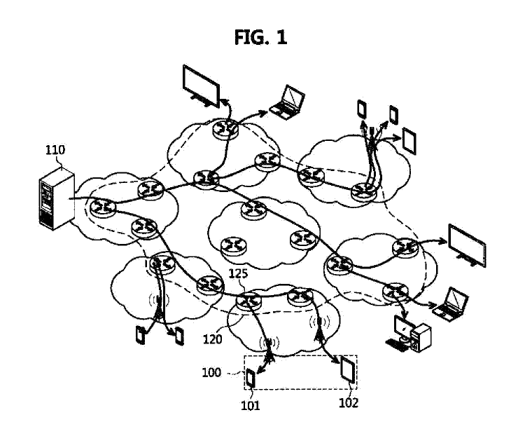

FIG. 1 is a conceptual diagram of an ICN environment, showing the concept of use of network resources in an ICN environment.

Referring to FIG. 1, an ICN includes data consumers 100 that request provision of data and receive the data in the network, a data supplier 110 that provides data to data consumers, and network nodes 120 that serve as a moving path of data between the data supplier 110 and a data consumer. In the ICN, all pieces of data have names for distinguishing the respective pieces of data from other pieces of data.

The data consumers 100 may be various devices that consume data. Each of the data consumers 100 may be constantly or temporarily connected to a network, and may request provision of data from another network device and receive the data. The data consumers 100 may be various devices, for example, a laptop computer, a desktop computer, a smartphone, a tablet PC, and a smart television (TV), and may have a wired or wireless connection to a network.

To request provision of data, the data consumers 100 may provide another network device with only the name of the data to be received rather than the IP address of a data supplier which stores the data. The name may be a combination of characters that distinguishes the data from other data.

The data nodes 120 may be various devices having an arithmetic function, a communication function, and a storage function. For example, the data nodes 120 may be servers. Each data node 120 may be connected to at least two devices among the data consumers 100, the data supplier 110, and other data nodes. Based on name information, the data node 120 may receive a data provision request message from at least one of the connected devices and transmit the data provision request message to another device, or may transfer data between the connected devices.

The data supplier 110 may be any of various devices having a communication function and a storage function. For example, the data supplier 110 may be a server. When another network device requests provision of data stored in the data supplier 110, the data supplier 110 provides the data to the other network device.

Here, the data supplier 110 determines whether the name of the data requested by the other network device is identical to the name of data stored in the data supplier 110, and provides the data to the other network device when the names are identical. Also, the data supplier 110 advertises data stored therein to the connected nearby network nodes 120 regardless of requests for provision of data.

In the ICN, provision of data from the data supplier 110 to a data consumer 100 may be performed by directly connecting the two network devices or connecting the two network devices through at least one data node 120. Since a plurality of network devices are connected in an actual network, the data supplier 110 and the data consumer 100 are connected through a plurality of network nodes 120 as shown in FIG. 1. At this time, another data consumer which requests provision of the data may be present in the network. For distinction, a data consumer which has requested the data provision from the data supplier 110 for the first time is referred to as a first consumer 101, and a data consumer which has requested the data provision for the second time is referred to as a second consumer 102. In the network, a data provision path from the data supplier 110 to the first consumer 101 and a data provision path to the second consumer 102 may include a plurality of nodes in common. Among the nodes included in common, a data node (referred to as a “common node” below) 125 which is the closest to a data consumer stores data requested by the first consumer 101 in a process of transferring the data. When the second consumer 102 requests provision of data, the common node 125 determines whether the name of requested data is identical to the name of data stored therein. When it is determined that the names are identical, the common node 125 can provide the stored data to the second consumer 125. Through this process, when the plurality of data consumers 100 request data having the same name in the ICN, the data supplier 110 does not provide the data to the data consumers 100, but the common node 125 can directly provide the data to the data consumers 100. Therefore, it is possible to reduce the overall network load as well as bottlenecks caused by loads concentrated at a portion of the network.

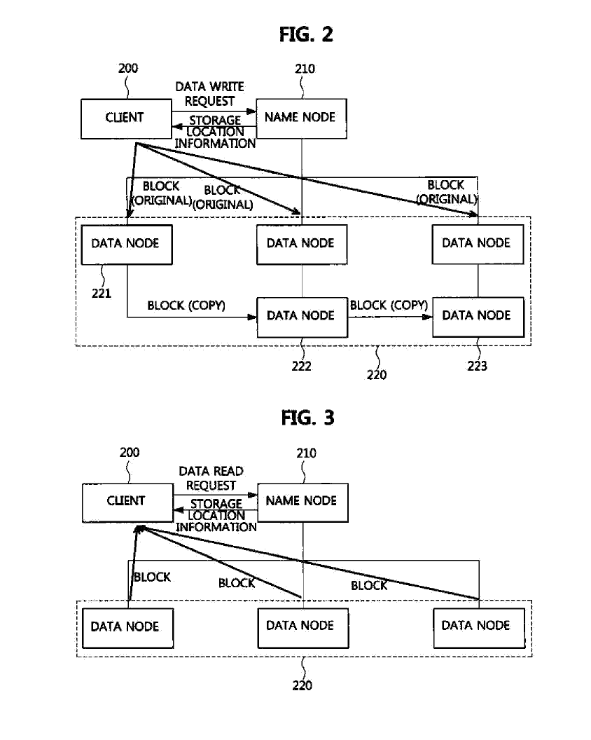

FIG. 2 is a block diagram showing a data write operation of a Hadoop distributed file system (HDFS).

Referring to FIG. 2, an HDFS includes a client 200, a name node 210, and a plurality of data nodes 220.

First, when the client 200 requests the name node 210 to notify the client 200 of the location of a data node 220 in which data will be stored to perform data writing, the name node 210 predicts that the data requested to be written will be divided into blocks of a uniform size, and provides IP address information of data nodes 220 in which the respective divided blocks will be stored to the client 200. In this process, the name node 210 stores the data nodes 220 and the IP address information corresponding to the data nodes 220 as metadata.

The client 200 needs to divide the data into several blocks and store the blocks in the data nodes 220 using the provided IP address information, and thus may use many network resources to store the data. For example, when one text file is divided into three blocks and stored in the HDFS, the client 200 communicates with the name node 210 one time to obtain IP address information for storing the blocks, and communicates with the data nodes 220 three times to transmit the three blocks. In other words, network resources are used a total of four times to store the one file. Also, each of the blocks is stored as the original and two copies due to characteristics of the HDFS, and thus use of network resources may further increase. For convenience of description, three data nodes which store the original and the two copies are referred to as a first data node 221, a second data node 222, and a third data node 223. Assuming that a data node which directly receives the original blocks from the client 200 is the first data node 221, the first data node 221 transmits the same blocks as (or a copy of the received blocks to the second and third data nodes 222 and 223. At this time, to distribute the use of network resources, the first data node 221 does not directly transmit the copy to the other two data nodes 222 and 223. The first data node 221 transmits the copy to the second data node 222, and the second data node 222 transmits the copy to the third data node 223. Here, the storage location of the original blocks does not limit the storage location of the copies. However, in the HDFS, at least one of the copies may be intentionally stored in a different rack from the original blocks of the copy in preparation for malfunction of or damage to the data nodes 220.

FIG. 3 is a block diagram showing a data read operation of an HDFS.

FIG. 3 assumes the same HDFS as shown in FIG. 2.

Referring to FIG. 3, first, the client 200 requests the IP addresses of data nodes 220 storing data from the name node 210 to perform data reading. The name node 210 may provide IP address information of the data requested to be read to the client 200 with reference to stored metadata. Here, when the requested data is divided into several blocks and stored, the IP address information may be the IP addresses of the several blocks.

The client 200 may receive the blocks corresponding to the requested data from the data nodes 220 using the provided IP address information, and may acquire the desired data by combining the received blocks.

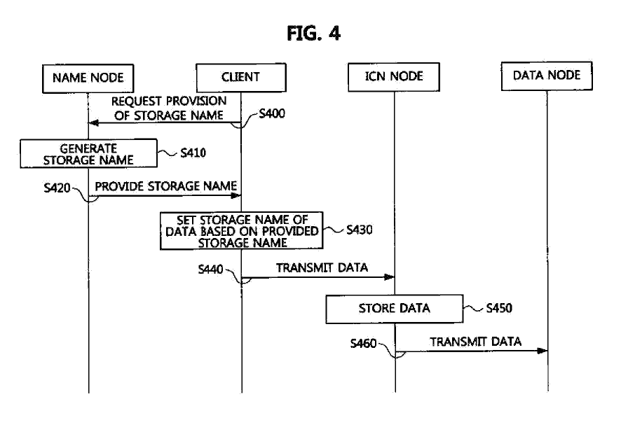

In example embodiments of FIGS. 4 to 9, it is assumed that computing devices having an arithmetic function, a communication function, and a storage function serve as components of an ICN-based DFS. For example, a server, a router having a storage function, etc. may serve as the components.

FIG. 4 is a sequence diagram illustrating a process of writing distributed files based on an ICN according to an example embodiment of the present invention, that is, a process of writing data in a data node when a client requests data writing in an ICN-based DFS including a name node, an ICN node, and the data node.

Referring to FIG. 4, first, a client may transmit a message for requesting provision of the storage name of data to be stored (S400).

Here, the storage name differs from the original name of the data, and is used instead of an IP address to specify a data node which will store the data.

When the DFS is set to divide the data and store the divided data, the client may divide the data into blocks of a predetermined uniform size and transmit a message for requesting provision of the storage names of the respective divided blocks to the name node. The predetermined uniform size is a size appropriate for reading or writing data, and is generally determined to be 64 MB in an HDFS. The size of blocks is not fixed and may vary according to the data processing performance of an HDFS or the data processing speed of a network. Through division, the data can be simultaneously stored in various data nodes.

Next, the name node may generate the storage name of the data of which provision has been requested by the client (S410). The name node generates the storage name of the data according to predetermined rules (referred to as a “naming policy” below). Therefore, the name node can generate the same storage name for pieces of data having the same characteristic. For example, the naming policy may be set to generate a storage name using the size and the type of data. In this case, when a video movie I having a size of 100 MB is requested to be written, the name node may generate the storage name “100_movie_data” for movie1. Here, generation of the storage name using the size and the type of data is merely one example, and the naming policy may be set to generate a storage name using various data characteristics including not only the size and the type of the data but also a data name, a data generation date, a data modification date, a person who has generated the data, and a location from which the data reading will be frequently requested so that the generated storage name is discriminable.

Also, based on the naming policy, the storage names of pieces of data or blocks may be generated to have hierarchical relationships with each other. For example, when the data input from the client is divided into four blocks, the storage names of the divided blocks may be determined to be data1, data2, data3, and data4. Further, when two copies of one block are additionally stored due to characteristics of the HDFS, the storage names of the copies of data1 may be determined to be data1.1 and data1.2. In this way, when the hierarchical concept of an existing directory scheme is applied to determination, of the storage names of a block and copies, it is possible to predict the storage name of a copy by accessing only the block in a data reading process.

The name node may include domain information in the storage name of data or blocks to determine the storage location of the data. For example, blocks having the storage names “domain1.data1.1,” “domain1.data1.2,” etc. may be stored in domain1. When the client intends to store the data in a specific data node (or a physical device) using the above-described method, or the data needs to be stored in a stable device having a wide bandwidth due to characteristics of the data to be stored, the ICN-based DFS may determine data nodes in which the data, the blocks, and the copies are stored, regardless of the naming policy (or with priority over the naming policy). In this case, the name node may store characteristics of the data or the blocks to be stored and a storage name reflecting a domain name corresponding to the characteristics in the form of metadata. Therefore, when a message for requesting provision of the storage name of the data is received from the client in a process of reading the data, the name node can generate a storage name reflecting the domain name.

Next, the name node may provide the generated storage name information to the client (S420).

Next, the client may set the storage name of the data based on the provided storage name (S430), and transmit the data whose storage name has been set to the ICN node (S440).

Next, the ICN node may store the transmitted data in a storage space thereof (S450), and may transmit the data to the data node according to the storage name of the data (S460).

Here, the ICN node may transmit the data using a policy protocol operating in conjunction with the naming policy of the name node. The policy protocol corresponds to rules in which a data node for storing data is determined according to the storage name of the data. The ICN node generates a forwarding table according to the policy protocol, searches the forwarding table for the storage name of the transmitted data and a data node corresponding to the storage name, and transmits the data to the found data node, thereby controlling flow of the data.

When two copies of each piece of data or each block are additionally stored in operations S400 to S460, the ICN node may predict the storage names of the two copies based on the naming policy. Therefore, it is possible to transmit a copy which has been received once to three data nodes without receiving all the copies from the client. In this way, the ICN node directly transmits stored data to a data node, so that the number of data transmissions between the client and the ICN node can be reduced, and network loads can also be reduced.

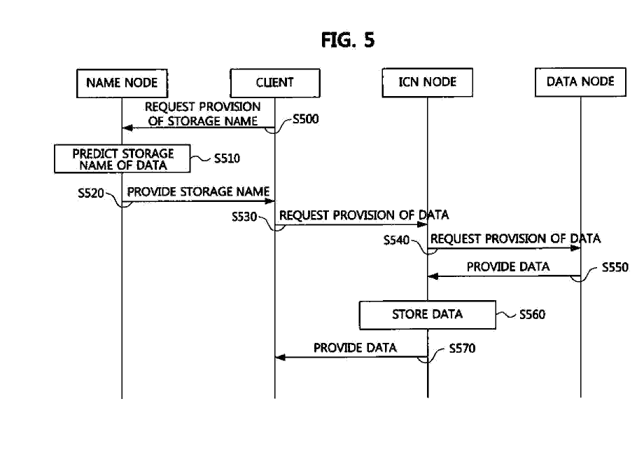

FIG. 5 is a sequence diagram illustrating a process of reading distributed files based on an ICN according to an example embodiment of the present invention, that is, a process in which a client receives information from a name node and reads data from a data node in a DFS.

FIG. 5 assumes the same RDFS as shown in FIG. 4 for convenience of description.

Referring to FIG. 5, first, the client may transmit a message for requesting provision of the storage name of data to be read (S500). When the DFS is set to divide data into blocks of a predetermined uniform size and store the divided blocks, the client may transmit a message for requesting provision of the storage names of the respective divided blocks.

Next, the name node may predict the storage name of data corresponding to the data of which provision has been requested based on a naming policy (S510), and may provide the predicted storage name information to the client (S520).

Next, the client may transmit a message for requesting provision of the data corresponding to the provided storage name to the ICN node (S530).

Next, the ICN node may transmit a message for requesting provision of the data using the storage name of the data of which provision has been requested to all data nodes connected thereto (S540). Among the data nodes connected to the ICN node, a data node which stores the requested data may provide the data in response to the request (S550).

Next, the ICN node may store the provided data in a storage space thereof first (S560), and may provide the data to the client (S570). Therefore, when a client which has once requested provision of data requests provision of the same data again, the ICN node can provide the data which is not stored in the data node but is stored in the ICN node. Also, even when there are a plurality of clients in the DFS and a client other than a client which has first requested provision of data requests provision of the same data, the ICN node can transmit the data stored therein. In this way, an ICN node directly transmits data stored therein to a client, so that the number of data transmissions between a data node and the ICN node can be reduced, and network loads can also be reduced.

When the client receives a plurality of block storage names from the name node, the data storage name information may be a plurality of pieces of block storage name information in operations S520 to S550. The data received by the client may be a plurality of blocks. In this case, the client may generate the data that the client has requested to read by combining the plurality of blocks. Also, when an original block stored in the data node is deleted or damaged and cannot be read, the name node may predict the storage name of a copy based on the naming policy and provide the predicted is storage name to the client The client receives the predicted storage name and can request reading of the copy. In this case, the ICN node also has a policy protocol which operates in conjunction with the naming policy and thus can predict the storage name of a copy. Therefore, the client can receive a copy without requesting the copy.

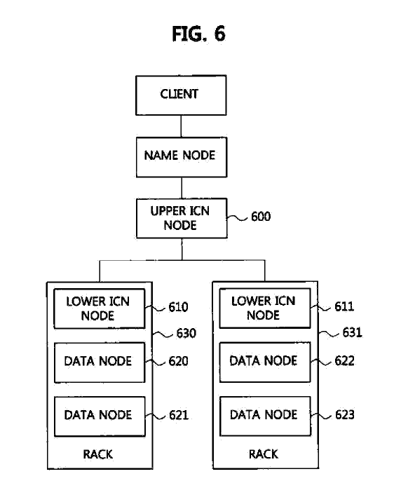

FIG. 6 is a block diagram showing a structure of an ICN-based DFS according to an example embodiment of the present invention, that is, a structure in which ICN nodes are hierarchically configured to transfer data.

Referring to FIG. 6, an ICN-based DFS may include an upper ICN node 600 which directly exchanges data with a client, and a first lower ICN node 610 and a second lower ICN node 611 which are connected to the upper ICN node 600. The lower ICN nodes 610 and 611 may transfer data between the upper ICN node 600 and a data node. The first and second lower ICN nodes 610 and 611 may be connected to two data nodes 620 and 621 and two data nodes 622 and 623, respectively. One lower ICN node and a plurality of data nodes can be included in one rack 630 or 631. In this structure, data reading and writing processes can be performed as follows.

In the data writing process, when data that the client has requested to write is stored in the 1-1 data node 620 and the 1-2 data node 621 in sequence, the data may be transmitted from the client to the 1-1 data node 620 through the upper ICN node 600 and the first lower ICN node 610. At this time, each of the upper ICN node 600 and the first lower ICN node 610 can store the transmitted data. Therefore, the 1-2 data node 621 to does not receive the data from the client and can receive the data stored in the first lower ICN node 610 and store the received data.

Also, when data that the client has requested to write is stored in the 1-1 data node 620 and the 2-1 data node 622 in sequence, the, data may be transmitted from the client to the 1-1 data node 620 through the upper ICN node 600 and the first lower ICN node 610. At this time, each of the upper ICN node 600 and the first lower ICN node 610 can store the transmitted data. Therefore, the 2-2 data node 622 does not receive the data from the client and can receive the data stored in the upper ICN node 600.

Through this process, it is possible to reduce duplicated data transmissions from a client when the same data needs to be transmitted several times in a data writing process of an ICN-based DFS due to copying, transmission failures, etc. of the data.

Next, in the data reading process, when data that the client has requested to read, is stored in the 1-1 data node 620, the data may be transmitted from the 1-1 data node 620 to the client through the first lower ICN node 610 and the upper ICN node 600. At this time, each of the upper ICN node 600 and the first lower ICN node 610 can store the transmitted data. Therefore, when the client requests reading of data that the client has once requested to read again, it is possible to receive the data stored in the upper ICN node 600.

Through this process, it is possible to reduce duplicated data transmissions from a data node when the same data is repeatedly read in a data reading process of an ICN-based DFS.

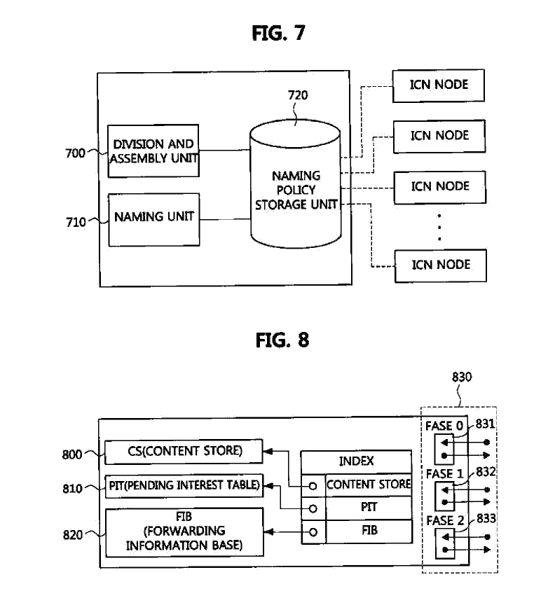

FIG. 7 is a block diagram showing a configuration of a name node according to an example embodiment of the present invention.

Referring to FIG. 7, a name node includes a division and assembly unit 700, a naming unit 710, and a naming policy storage unit 720.

To increase efficiency in data management, the division and assembly unit 700 may divide data which has been requested to be written into blocks of a predetermined uniform size and manage the divided blocks. Also, the division and assembly unit 700 may generate original data by combining blocks corresponding to the data which has been requested to be read.

The naming unit 710 may predict the storage name of data which has been requested to be written or read. The naming unit 710 may predict a storage name corresponding to characteristics of data which has been requested to be read or written using a stored naming policy. Therefore, even when the amount of stored data increases, metadata for managing the data may not increase.

The naming policy stored in the naming policy storage unit 720 may operate in conjunction with a policy protocol of a connected ICN node.

FIG. 8 is a block diagram showing a configuration of an ICN node according to an example embodiment of the present invention.

Referring to FIG. 8, an ICN node may include a content store (CS) 800, a pending interest table (FIT) 810, a forwarding information base (FIB) 820, and faces 830.

When a data provision request is received from a client or another ICN node, the ICN node may sequentially search the CS 800, the PIT 810, and the FIB 820 for data

The CS 800 is a cache for storing data which passes through the ICN node. When the name of data of which provision is requested is identical to the name of data stored in the CS 800, the ICN node may transmit the stored data in response to the request.

The PIT 810 is the record of a path of a data provision request message. When the data is found in the PIT 810, the ICN node determines that provision of the data has already been requested by another network node or another data consumer and is requested from other network nodes through the ICN node, and waits for a response of the other network nodes. At this time, the data provision request is repeated if the data does not arrive within a predetermined time, and the request is deleted if the data does not arrive within a predetermined time after the repetition.

The FIB 820 is a cache for efficiently forwarding a data provision request. When the data is found in the FIB 820, the ICN node broadcasts the data provision request to other ICN nodes, deletes the data name from the FIB 820, and adds the data name to the PIT 810. On the other hand, when the data is not found in the FIB 820 either, the ICN node determines that the data cannot be processed at the corresponding node and deletes the data provision request.

A face is a data forwarding channel of the ICN node. The ICN node includes the plurality of faces 830. Since each of the faces 830 can be connected to one of the client, another ICN node and a data node, the ICN node can support multiple connections between nodes (the client, the other ICN node, the data node, etc.) through the faces 830. For example, the ICN node can receive the data through Face0 831, store the received data in the CS 800, and provide the stored data through Face1 832 and Face2 833.

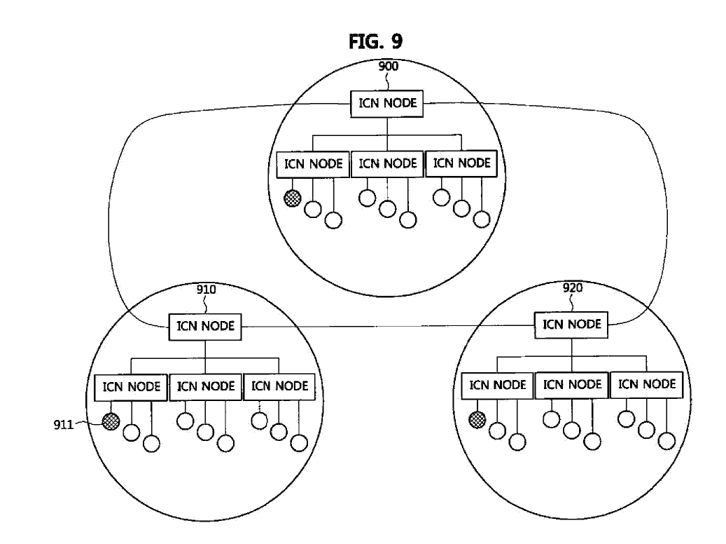

FIG. 9 is a block diagram showing a structure of an ICN-based DFS according to an example embodiment of the present invention, that is, a structure of an ICN-based DFS configured in several Internet data centers (IDCs).

Referring to FIG. 9, it is assumed that an ICN-based DFS is configured to be divided into three IDCs, and a DFS configured in each IDC includes an upper ICN node which directly receives data from a client, lower ICN nodes which connect the upper ICN node with data nodes, and at least one data node included in each of the lower ICN nodes. For distinction, the three upper ICN nodes are referred to as a first ICN node 900, a second ICN node 910, and a third ICN node 920. The first to third ICN nodes 900 to 920 can be connected and exchange data with each other. Here, components of the ICN-based DFS included in one IDC are at a physically close distance from each other, and components of the ICN-based DFS included in different IDCs are at a physically long distance from each other.

To describe data transmission efficiency in the structure of the ICN-based DFS described above, the following is given as an example. It is assumed that a first client and a second client are at a physically close distance from the first ICN node 900 and data that the first and second clients request to read is stored in a data node 911 subordinate to the second ICN node 910. In this case, the data that the first client has requested to read may pass through the second ICN node 910 and the first ICN node 900 which is physically close to the first client in a process of the data being provided from the data node 911 in which the data is stored to the first client. Each of the first and second ICN nodes 900 and 910 can store the data in its CS. At this time, if the second client also requests reading of the data that the first client has requested to read, the second client can receive the data from the second ICN node 910 because the requested data is also stored in the second ICN node 910 which is physically close to the second client. Therefore, the second client can read the data using a small amount of network resources. The data transmission process is also applied to a data writing process, and network resources can be efficiently used through the same process.

According to the above-described apparatus and method for managing distributed files based on an ICN, in a process of reading and writing data from and in a storage device, a client manages data not based on a storage address but based on the name of data to be stored. Therefore, duplication of a data access path is prevented, and the overall network load can be reduced.

Also, data becomes the central entity of a network, so that functions of a security device can be performed. Therefore, it is possible to improve the security of the whole network.

While the example embodiments of the present invention and their advantages have been described in detail, it should be understood that various changes, substitutions and alterations may be made herein without departing from the scope of the invention.

What is claimed is:

1. A method of managing distributed files based on an information-centric network (ICN) performed by a name node, the method comprising:
receiving a message for requesting provision of a storage name required to store or read data from a user terminal;
generating a storage name so that the data indicated by the message is discriminable; and
transmitting the generated storage name to the user terminal.

2. The method of claim 1, wherein the receiving of the message comprises receiving characteristic information of the data from the user terminal.

3. The method of claim 2, wherein the generating of the storage name comprises generating a storage name reflecting the received characteristic information of the data.

4. The method of claim 3, wherein the characteristic information of the data includes of least one piece of information among a data name, a data size, a data type, a data generation date, a data modification date, a person who has generated the data, and a location from which reading of the data will be frequently requested.

5. The method of claim 4, wherein the characteristic information of the data further includes at least one piece of information of block numbers of the data and a copy number of the data.

6. The method of claim 4, wherein the characteristic information of the data further includes information on a location in which the data will be stored.

7. The method of claim 6, wherein the generating of the storage name comprises, when a storage name reflecting the information of the location in which the data will be stored is generated, storing the characteristic information and the storage name in a form of metadata.

8. A method of storing distributed files based on an information-centric network (ICN) performed by a user terminal, the method comprising:
transmitting a message for requesting provision of a storage name required to store data to a name node;
receiving the storage name from the name node;
setting the received storage name as a name of the data; and
providing the data whose name has been set to an ICN node.

9. The method of claim 8, wherein the transmitting of the message comprises providing characteristic information of the data.

10. The method of claim 9, wherein the characteristic information of the data includes at least one piece of information among a data name, a data size, a data type, a data generation date, a data modification date, a person who has generated the data, and a location from which reading of the data will be frequently requested.

11. The method of claim 10, wherein the characteristic information of the data further includes at least one piece of information of block information of the data and copy information of the data.

12. The method of claim 10, wherein the characteristic information of the data further includes information on a location in which the data will be stored.

13. The method of claim 10, wherein the transmitting of the message comprises dividing the data into blocks of a predetermined uniform size, and transmitting a message for requesting storage names of the respective divided blocks to the name node.

14. A method of managing distributed files based on an information-centric network (ICN) performed by an ICN node, the method comprising:
receiving a message for requesting provision of data from a first network node;
determining whether a name of the requested data is identical to a name of data stored in the ICN node; and
adaptively providing the data to the first network node based on a result of the determination.

15. The method of claim 14, wherein the providing of the data comprises, when the result of the determination indicates that the name of the requested data is identical to a name of data stored in the ICN node, providing the data stored in the ICN node to the first network node.

16. The method of claim 14, wherein the providing of the data comprises:
when the result of the determination indicates that the name of the requested data is not identical to a name of data stored in the ICN node, transmitting a message for requesting provision of the data to a second network node connected to the ICN node;
receiving the data in response to the request message; and
providing the received data to the first network node.

17. The method of claim 16, wherein the providing of the received data comprises storing the received data in a storage space of the ICN node, and providing the received data to the first network node.

18. The method of claim 14, further comprising generating a forwarding table based on a first rule defining storage names and data nodes corresponding to the storage names.

19. The method of claim 18, further comprising receiving a second rule used to generate the storage names from a name node.

20. The method of claim 19, further comprising updating the first rule based on the second rule.
